(19) United States
(12) Patent Application Publication
(10) Pub. No.: US 2021/0129294 A1
(43) Pub. Date: May 6, 2021

(54) PICKING TOOL

(71) Applicant: TRIPLE WIN TECHNOLOGY(SHENZHEN) CO.LTD., Shenzhen (CN)

(72) Inventor: SHENG LIU, Shenzhen (CN)

(21) Appl. No.: 16/883,888

(22) Filed: May 26, 2020

(30) Foreign Application Priority Data
Oct. 30, 2019 (CN) 201921851099.0

(51) Int. Cl. B25B 9/02; G07C 3/10

(52) U.S. Cl. CPC B25B 9/02; G07C 3/10

(57) ABSTRACT

A picking tool includes a main body, a pressure sensor mounted on the main body, a memory, and a display screen. The main body includes a picking portion. The pressure sensor is located on the picking portion. The pressure sensor is pressed when the main body picks an object. The memory is electrically coupled to the pressure sensor and configured to obtain a total number of sensed pressure signals from the pressure sensor. The display screen is electrically coupled to the memory and configured to display the total number of sensed pressure signals.

### FIELD

The subject matter herein generally relates to a picking tool, and more particularly to a picking tool for counting the number of times of picking an object.

### BACKGROUND

Generally, picking tools (such as tweezers) do not have a counting function during use, so that manual counting is required for counting the number of times of picking an object. However, manual counting is error-prone and time-consuming and laborious.

### BRIEF DESCRIPTION OF THE DRAWINGS

Implementations of the present disclosure will now be described, by way of embodiments, with reference to the attached figures.

FIG. 1 is an assembled, isometric view of a first embodiment of a picking tool.

FIG. 2 is an assembled, isometric view of a second embodiment of the picking tool.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

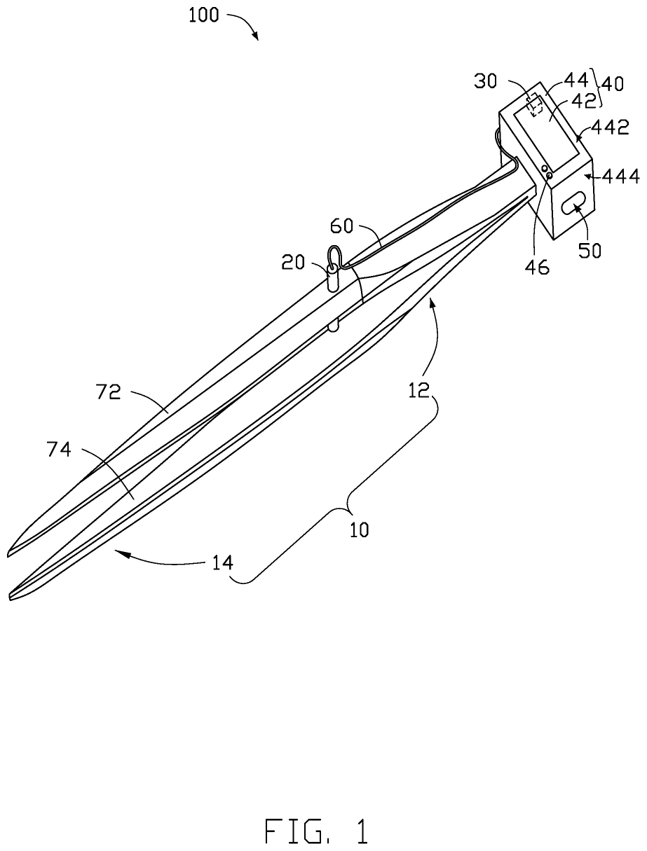

FIG. 1 shows a first embodiment of a picking tool 100. The picking tool 100 includes a main body 10, a sensor 20, a memory 30, and a mounting portion 40. A display screen 42 is provided on the mounting portion 40.

The main body 10 is used for picking an object, such as by clamping. The main body 10 includes an operating portion 12 and a picking portion 14 connected to the operating portion 12. The operating portion 12 is held by a user for holding the picking tool 100. The picking portion 14 is used for picking an object.

The sensor 20 is located at an end of the operating portion 12 adjacent to the picking portion 14. The memory 30 is located in the mounting portion 40. In one embodiment, the mounting portion 40 is located on an end of the operating portion 12 away from the picking portion 14.

The sensor 20 is electrically connected to the memory 30, and the display screen 42 is electrically connected to the memory 30. The sensor 20 senses a pressure signal during use. Each time a pressure signal is sensed, the sensed pressure signal is transmitted to the memory 30. The memory 30 stores a total number of the sensed pressure signals, and the display screen 42 displays the total number of the sensed pressure signals. The total number of the sensed pressure signals represents the number of picked objects.

The mounting portion 40 further includes a frame 44, which is substantially a rectangular parallelepiped. The frame 44 is fixed to the end of the operating portion 12 away from the picking portion 14. The frame 44 includes an upper surface 442 and a side surface 444. The upper surface 442 is substantially perpendicular to the side surface 444, and the display screen 42 is located on the upper surface 442.

Further, at least one button 46 is provided on the frame 44 on a periphery of the display screen 42. The at least one button 46 may be used for setting a zero return function, a count function, an addition and subtraction function, and the like.

The picking tool 100 is further provided with a power component 50 electrically connected to the sensor 20, the memory 30, and the display screen 42. In one embodiment, the power component 50 is a USB interface. The USB interface is disposed on the side surface 444. An external power source charges the picking tool 100 through the USB interface. In other embodiments, the power component 50 is a battery, and the battery provides power for the picking tool 100.

When the main body 10 is not in use, the display screen 42 can be set to display other contents, such as time, according to user needs.

As shown in FIG. 1, the main body 10 is a pair of tweezers. The tweezers include a first clamping arm 72 and a second clamping arm 74. The first clamping arm 72 and the second clamping arm 74 are fixedly connected at one end, and separated at the other end. The main body 10 forms the operating portion 12 adjacent to a connection portion between the first clamping arm 72 and the second clamping arm 74, and the picking portion 14 adjacent to the separated portion of the first clamping arm 72 and the second clamping arm 74. The sensor 20 is located in the picking portion 14 between the first clamping arm 72 and the second clamping arm 74. More specifically, the sensor 20 is located substantially in a middle region of the first clamping arm 72 and protrudes through the first clamping arm 72. In one embodiment, the sensor 20 is a pressure sensor. The memory 30 and the mounting portion 40 are located at the end of the operating portion 12 away from the picking portion 14. The sensor 20 is electrically connected to the memory 30 through a wire 60. In the first embodiment, the power component 50 is a USB interface.

When the tweezers are used, that is, when the picking portion 14 is pressed, a relative distance between the first clamping arm 72 and the second clamping arm 74 decreases until the sensor 20 is pressed by the second clamping arm 74. The sensor 20 senses a pressure signal and transmits the pressure signal to the memory 30 for counting, and then the display screen 42 displays the count of the sensed pressure signal. Each time the picking portion 14 is pressed for picking an object, the sensor 20 senses the pressure signal and transmits the pressure signal to the memory 30 for cumulative counting. The display screen 42 displays the total number of the sensed pressure signals in real time.

In one embodiment, the sensor 20 is movably disposed on the first clamping arm 72. Thus, a distance between the sensor 20 and the second clamping arm 74 is adjusted according to the size of the object to be picked, so that the sensor 20 can sense the signals when picking objects of different sizes.

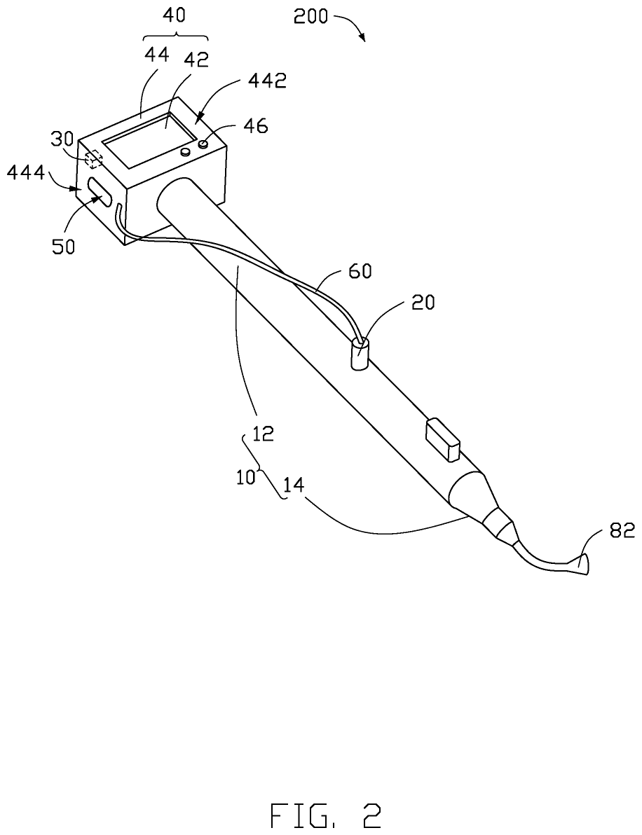

FIG. 2 shows a second embodiment of a picking tool 200. In the second embodiment, the main body 10 is a suction pen, and the suction pen is substantially cylindrical. One end of the suction pen is provided with a suction cup 82. A portion of the main body 10 adjacent to the suction cup 82 is the picking portion 14, and a remaining portion of the main body 10 is the operating portion 12. The sensor 20 is located on the operating portion 12 adjacent to the suction cup 82. The sensor 20 communicates with the suction cup 82. The sensor 20 is used for sensing a change in a vacuum in the suction cup 82. In the second embodiment, the sensor 20 is a vacuum sensor. The memory 30 and the mounting portion 40 are provided at the end of the operating portion 12 away from the picking portion 14. The sensor 20 is electrically connected to the memory 30 through the wire 60. In the second embodiment, the power component 50 is a USB interface.

When using the suction pen, the sensor 20 senses a vacuum signal from the suction cup 82 and transmits the vacuum signal to the memory 30 for counting, and then the display screen 42 displays the number of the sensed vacuum signals. The memory 30 cumulatively counts the sensed vacuum signals, and the display screen 42 displays a total number of the sensed vacuum signals in real time.

The picking tool 200 uses the sensor 20, the memory 30, and the mounting portion 40 for counting the total number of times of picking and placing an object, thereby replacing manual counting and saving time and effort.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A picking tool comprising:
a main body;
a pressure sensor mounted on the main body;
a memory; and
a display screen; wherein:
the main body comprises a first clamping arm and a second clamping arm;
a first end of the first clamping arm and a first end of the second clamping arm are fixedly coupled;
the main body comprises an operating portion adjacent to the first end of the first clamping arm and the first end of the second clamping arm;
a second end of the first clamping arm and a second end of the second clamping arm are separated;
the main body comprises a picking portion adjacent to the second end of the first clamping arm and the second end of the second clamping arm;
the pressure sensor is located on the picking portion between the first clamping arm and the second clamping arm;
the pressure sensor is pressed when the first clamping arm and the second clamping arm pick an object;
the memory is electrically coupled to the pressure sensor and configured to obtain a total number of sensed pressure signals from the pressure sensor; and
the display screen is electrically coupled to the memory and configured to display the total number of sensed pressure signals.

2. The picking tool of claim 1, wherein:
the pressure sensor is movably disposed on the first clamping arm or the second clamping arm.

3. The picking tool of claim 1, further comprising a power component, wherein:
the power component is electrically coupled to the pressure sensor, the memory, and the display screen.

4. The picking tool of claim 3, wherein:
the power component comprises at least one of a USB port and a battery.

5. The picking tool of claim 4, further comprising a frame; wherein:
the frame is mounted on the operating portion; and
the display screen is mounted on the frame.

6. The picking tool of claim 5, wherein:
the frame comprises at least one button electrically coupled to the memory.

7. The picking tool of claim 5, wherein:
the power component is mounted on the frame.

8. A picking tool comprising:
a main body;
a vacuum sensor mounted on the main body;
a memory; and
a display screen; wherein:
the main body comprises an operating portion and a picking portion coupled to the operating portion;
the picking portion comprises a suction cup;
the vacuum sensor is mounted on the main body and coupled to the suction cup;
the vacuum sensor is configured to sense a vacuum signal when the suction cup picks an object;
the memory is electrically coupled to the vacuum sensor and configured to obtain a total number of sensed vacuum signals from the vacuum sensor; and
the display screen is electrically coupled to the memory and configured to display the total number of sensed vacuum signals.

9. The picking tool of claim 8, further comprising a power component, wherein:
the power component is electrically coupled to the vacuum sensor, the memory, and the display screen.

10. The picking tool of claim 9, wherein:
the power component comprises at least one of a USB port and a battery.

11. The picking tool of claim 10, further comprising a frame; wherein:
the frame is mounted on the operating portion; and
the display screen is mounted on the frame.

12. The picking tool of claim 11, wherein:
the frame comprises at least one button electrically coupled to the memory.

13. The picking tool of claim 11, wherein:
the power component is mounted on the frame.
